(19) United States
(12) Patent Application Publication
(10) Pub. No.: US 2005/0076135 A1
(43) Pub. Date: Apr. 7, 2005

(54) UDDI web service registry system based on an ebXML registry and management method therefor

(76) Inventors: Byoung Youl Song, Daejeon (KR); Rockwon Kim, Daejeon (KR); Kyung-Il Kim, Daejeon (KR); Hyun Kyu Cho, Daejeon (KR); Duk Joo Son, Daejeon (KR); Jae-Hong Park, Daejeon (KR); Sang-Kyun Kim, Daejeon (KR); Kyu Chul Lee, Daejeon (KR)

Correspondence Address: JACOBSON HOLMAN PLLC, 400 SEVENTH STREET N.W., SUITE 600, WASHINGTON, DC, 20004, US

(21) Appl. No.: 10/601,867

(22) Filed: Jun. 24, 2003

(30) Foreign Application Priority Data
Nov. 22, 2002 (KR) 10-2002-73183

(51) Int. Cl. G06F 15/16

(52) U.S. Cl. 709/230

(57) ABSTRACT

In an UDDI web service registry system based on an ebXML registry, a first client system supports a web service based on an UDDI protocol and transceives an UDDI message. An UDDI registry processes a service request of the UDDI message. A second client system supports a web service based on an ebXML protocol and transceives an ebXML message. An ebXML registry processes service requests of the compatible ebXML message. An UDDI service module transforms the UDDI message into a compatible ebXML message and transmits the ebXML message to the ebXML registry.

### FIELD OF THE INVENTION

The present invention relates to a web service registry technology; and, more particularly, to an UDDI web service registry system and a management method therefor based on an ebXML registry, which are capable of processing a universal description discovery integration (UDDI) service for a web service in an ebXML registry system when an electronic business extensible Markup Language (ebXML) is commercialized, wherein the ebXML is an international e-Business standard platform established by an United Nations Center for the Facilitation of Procedures and Practices for Administration, Commerce and Transport (UN/CEFACT) as an international EDI standard development organization and an Organization for the Advancement of Structures Information Standards (OASIS) as an international Internet information exchange consortium.

### BACKGROUND OF THE INVENTION

Recently, a universal description discovery integration (UDDI) is being widely used due to an increase in an interest in a web service. An UDDI registry refers to an XML-based public registry designed for storing and processing information on Internet business and corresponding services in a structured manner. By using the UDDI registry, it is possible to post and search information on a company, a web service provided by the company and a service technique interface of the company. Since technical data are searched by an interaction during a design time and a running time through a series of simple object access protocol (SOAP)-based XML application programming interface (API) calls, the UDDI functions as an infrastructure of a web service-based software environment. However, the UDDI is not sufficient to be used as an ebXML.

Meanwhile, an ebXML has recently attracted a great deal of attention as a new technical standard of a B2B electronic commerce. The ebXML is a public protocol for connecting e-commerce systems separately promoted by each corporation all over the world.

An ebXML registry contains metadata that is information presented by business partners. In this case, the stored information is used for performing ebXML-based B2B cooperation and transactions, and therefore, it is able to discover an identity of the other party and their services.

Even if the ebXML registry has a basic information model for a web service, the ebXML registry does not provide an intuitive interface as an UDDI registry does. Further, in order to use the ebXML registry, a full knowledge of an ebXML standard information model is required, so that the ebXML registry is difficult to be used.

If a function of a web service registry and that of an e-business registry are required to construct a web service system through an UDDI, two systems are needed to execute each function. Moreover, since same web service information are managed by different systems, the information are not consistently managed.

### SUMMARY OF THE INVENTION

It is, therefore, a primary object of the present invention to provide an UDDI web service registry system based on an ebXML registry, which is capable of reducing system construction costs by adding an UDDI service module for constructing two types of systems as one in case two functions of an e-business and a web service are required so that UDDI message can be processed in an ebXML registry and also capable of maintaining consistency of an information management by using one system for managing same web service information.

It is another object of the present invention to provide a method for managing an UDDI web service registry system based on an ebXML registry, which is capable of reducing system construction costs by adding an UDDI service module for constructing two types of systems as one in case two functions of an e-business and a web service are required so that UDDI message can be processed in an ebXML registry and also capable of maintaining consistency of an information management by using one system for managing same web service information, wherein the management method involves receiving an UDDI request message from a client system supporting an UDDI, transforming the received message into a compatible ebXML message, transmitting the transformed ebXML message to an ebXML registry, receiving an ebXML response message from the ebXML registry, transforming the ebXML message into a compatible UDDI message and transmitting the transformed UDDI message to a client system that requested a service.

In accordance with one aspect of the invention, there is provided an UDDI web service registry system based on ab ebXML registry including: a first client system for supporting a web service based on an UDDI protocol and transceiving an UDDI message; an UDDI registry for processing a service request of the UDDI message; a second client system for supporting a web service based on an ebXML protocol and transceiving an ebXML message; an ebXML registry for processing service requests of the compatible ebXML message; and an UDDI service module for transforming the UDDI message into a compatible ebXML message and transmitting the ebXML message to the ebXML registry.

In accordance with another aspect of the invention, there is provided a method for managing an UDDI web service registry system based on an ebXML registry, the method including the steps of: (a) checking whether an UDDI message is received from a client system; (b) checking whether a service request of the UDDI message is a registration request or a query request in case the UDDI message is received; (c) checking whether there exists an information storage key in the ebXML registry in case the service request of the UDDI message is the registration request; (d) transforming the received UDDI message into a compatible ebXML message having an update request according to an ebXML protocol in case there exists the information storage key; (e) transforming the received UDDI message into a compatible ebXML message having a registration request according to an ebXML protocol in case the information storage key does not exist; and (f) transmitting the transformed ebXML message to the ebXML registry.

In accordance with still another aspect of the invention, there is provided a method for managing an UDDI web service registry system based on an ebXML registry, the method including the steps of: (a′) checking whether an ebXML message is received from the ebXML registry; (b′) checking whether a response type of the received ebXML message is a registration response or a query response; (c′) transforming the ebXML message into a compatible UDDI message having a response of an error code or a result code according to an UDDI protocol in case the ebXML message type is the registration response; (d′) transforming the ebXML message into a compatible UDDI message having a response based on an instance in received information or an error-processed response according to an UDDI protocol depending on whether a response result conforms to a query object in case the ebXML message is the query response; and (e′) transmitting the transformed UDDI message to a request client system.

### BRIEF DESCRIPTION OF THE DRAWINGS

The above and other objects and features of the present invention will become apparent from the following description of preferred embodiments, given in conjunction with the accompanying drawings, in which:

FIG. 1 shows a general drawing of an UDDI web service registry system based on an ebXML registry in accordance with a preferred embodiment of the present invention;

FIG. 2 illustrates a diagram of a preferred embodiment of an UDDI service module shown in FIG. 1;

FIG. 3 depicts a flowchart of processes for transforming an UDDI message into an ebXML message and transmitting the ebXML message in the UDDI web service registry system based on the ebXML registry in accordance with a preferred embodiment of the present invention; and

FIG. 4 provides a flowchart of processes for transforming an ebXML message into an UDDI message and transmitting the UDDI message in the UDDI web service registry system based on the ebXML registry in accordance with a preferred embodiment of the present invention.

### DETAILED DESCRIPTION OF THE PREFERRED EMBODIMENTS

Hereinafter, preferred embodiments of the present invention will be described with reference to the accompanying drawings.

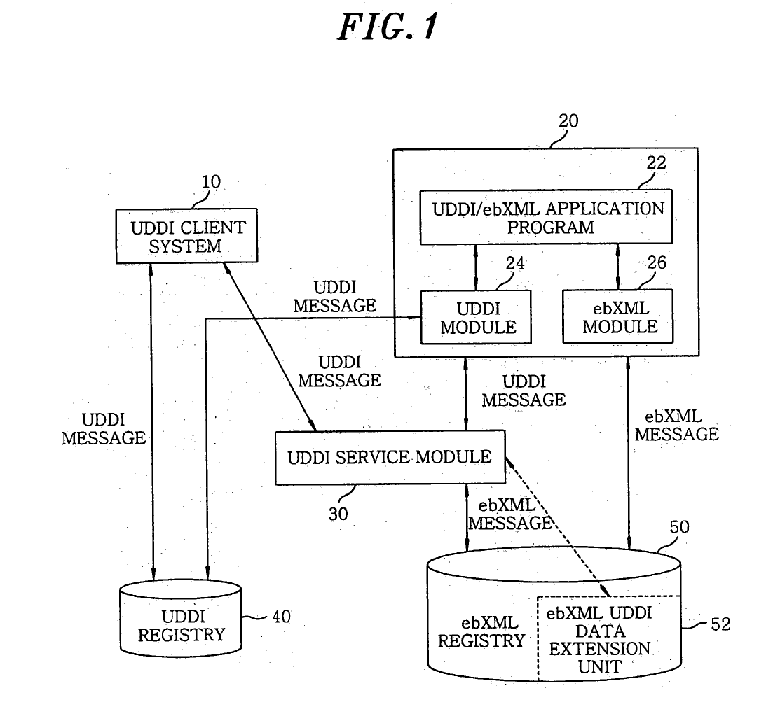

FIG. 1 shows a general drawing of an UDDI web service registry system based on an ebXML registry in accordance with a preferred embodiment of the present invention.

As can be seen from FIG. 1, the UDDI web service registry system of the present invention comprises a first client system 10, i.e., an UDDI client system, a second client system 20, i.e., a system supporting an ebXML protocol, an UDDI service module 30, an UDDI registry 40 and an ebXML registry 50.

In this preferred embodiment, the first client system 10 supports a web service based on an UDDI protocol and transceives an UDDI message. In this case, the first client system 10 may further include a module (not shown in FIG. 1) for transmitting/receiving an ebXML message to/from the ebXML registry 50 through an ebXML message application program.

The second client system 20 supports a web service based on an ebXML protocol and transceives an ebXML message. In this preferred embodiment, the second client system 20 further includes an UDDI/ebXML application program 22, an UDDI module 24 and an ebXML module 26 in order to support web services based on both an UDDI protocol and an ebXML protocol.

The UDDI registry 40 processes a service request of an UDDI message transmitted from the first client system 10 or the second client system 20 according to its processing rule and then transmits a processing result to the client system 10 and 20.

The ebXML registry 50 processes a service request of an ebXML message transmitted from the ebXML module 26 of the second client system 20 or an ebXML message transformed by the UDDI service module 30 according to its processing rule and then transmits a processing result to the ebXML module 26 or the UDDI service module 30.

The UDDI service module 30, which is newly added in the present invention, transforms an UDDI message of the first or the second client system 10 or 20 into a compatible ebXML message and then transmits it to the ebXML registry 50.

Meanwhile, the ebXML response message transmitted to an UDDI service module 30 can be reconstituted according to an UDDI protocol during a data transform process. At this time, if information is insufficient for transforming an ebXML message into an UDDI message, an ebXML UDDI data extension unit 52 separately installed in the ebXML registry 50 provides information to thereby reconstitute a final UDDI response message. Thereafter, the reconstituted UDDI response message is transmitted to the first or the second client system 10 or 20 that requested a service.

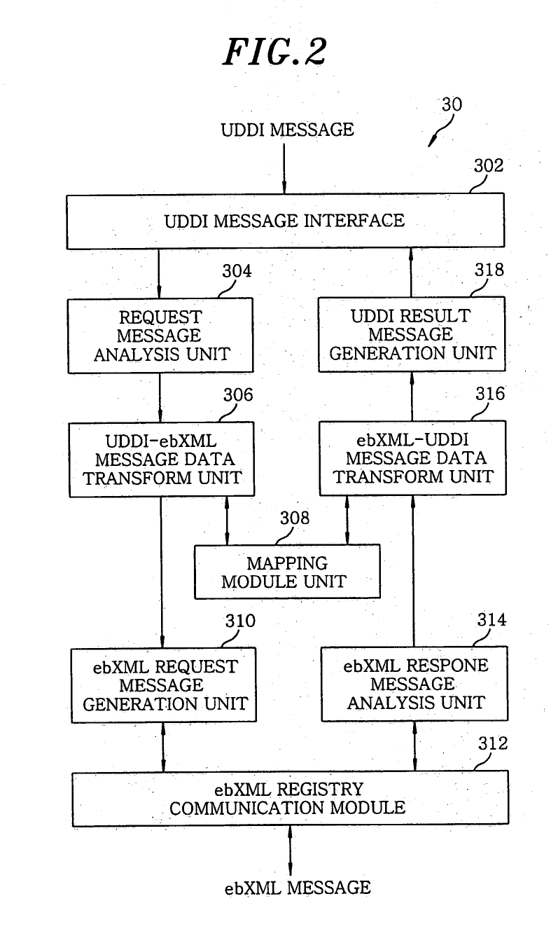

FIG. 2 illustrates a diagram of a preferred embodiment of an UDDI service module. Referring to FIG. 2, the UDDI service module 30 of the present invention includes an UDDI message interface 302, a request message analysis unit 304, an UDDI-ebXML message data transform unit 306, a mapping module unit 308, an ebXML request message generation unit 310, an ebXML registry communication module 312, an ebXML response message analysis unit 314, an ebXML-UDDI message data transform unit 316 and an UDDI result message generation unit 318.

The UDDI message interface 302 receives an UDDI service request message from the UDDI module 24 of the first or the second client system 10 or 20. After an ebXML response message transmitted from the ebXML registry 50 is transformed into an UDDI message, the UDDI message interface 302 transmits the UDDI message to the client system 10 or 20.

The request message analysis unit 304 inspects whether the UDDI message transmitted from the UDDI message interface 302 is based on an UDDI protocol and then analyzes a service request, e.g., a registration request or a query request in the UDDI message.

Based on the message request information analyzed by the request message analysis unit 304, the UDDI-ebXML message data transform unit 306 transforms an UDDI message into an ebXML service request message so that the ebXML service request message can be processed in the ebXML registry 50.

For example, in case a request of an analyzed UDDI message is an information storage request, the UDDI-ebXML message data transform unit 306 transforms a received UDDI message into an ebXML message having an update request or a registration request depending on existence or nonexistence of an information storage key in the ebXML registry 50. If a request of the analyzed UDDI message is a deletion request, a received UDDI message is transformed into an ebXML message according to an ebXML protocol, the ebXML message having a cancellation request or a deletion request depending on whether or not there exists reference or related information between a to-be-deleted instance and another instance in the ebXML registry 50.

Further, in case a query object of an analyzed UDDI message is a business entity, the UDDI-ebXML message data transform unit 306 transforms an UDDI message into an ebXML query message by setting an organization instance for the query object of the received UDDI message. If a query object of an UDDI message is a business service, the UDDI message is transformed into en ebXML query message by setting a service instance for the query object of the received UDDI message. In case a query object of an UDDI message request is a binding template, the UDDI message is transformed into an ebXML query message by setting a service binding instance for the query object thereof. Still further, if a query object of an UDDI message request is a grouping model, the UDDI message is transformed into an ebXML query message by setting a specification link instance, a classification scheme instance and a classification node instance for the query object thereof.

In this case, the business entity among an UDDI data structure indicates contact information such as a name, a telephone number and a website address of a service provider as well as basic business information such as an identifier and a category for identifying a business enterprise. The business service provides information on services provided by the business entity, i.e., a categorization of services based on an industry, a product and a region, a function of a service and a logical service categorization related to a business process or a service set. The binding template provides technical information for using a service, i.e., a web service for mapping between a business service and a grouping model. Services are categorized depending on an UDDI data model and grouped according to a certain type apart from a categorization standard. The grouping model is an entity for managing such categorization standard and type standard.

The organization instance among an ebXML data structure contains information on a business enterprise. The service instance contains rough information on services provided by the organization instance. The service binding instance, which provides information for using a service, serves to bind a service instance with the specification link instance or with other information. The specification link instance functions to recognize a certain classification scheme having a classification node instance as a sub-instance. The classification node instance represents a detailed classification of a specific classification scheme.

The mapping module 308 is used for mapping and managing compatibility and a data transform between an UDDI-ebXML message data and an ebXML-UDDI message data respectively transformed by the UDDI-ebXML message data transform unit 306 and the ebXML-UDDI message data transform unit 316. As can be seen from Table 1, the mapping is performed based on a correlation between the UDDI data structure and the ebXML data structure.

TABLE 1

| UDDI data | ebXML data |
|---|---|
| business entity | organization instance |
| business service | service instance |
| binding template | service binding instance |
| grouping model | specification link instance, |
| | classification scheme instance, |
| | classification node instance |

The ebXML request message generation unit 310 generates an ebXML service request message (including the above-described registration request or query request) transformed by the UDDI-ebXML message data transform unit 306.

The ebXML registry communication module 312 transmits the ebXML request message generated by the ebXML request message generation unit 310 to the ebXML registry 312 or an ebXML response message received from the ebXML registry 50 to the ebXML response message analysis unit 314.

The ebXML response message analysis unit 314 checks whether the ebXML response message transmitted from the ebXML registry 50 is requested by a certain service and then analyzes a response type of the response message.

The ebXML-UDDI message data transform unit 316 transforms the ebXML response message into a compatible UDDI message according to the response type of the ebXML message analyzed by the ebXML response message analysis unit 314.

For example, in case an analyzed ebXML message type is a registration response, the ebXML-UDDI message data transform unit 316 transforms the received ebXML message into an UDDI message of an error code response or a certain result code response depending on a registration processing result in the ebXML registry 50. In other words, if the registration process is unsuccessful, the processing result report is generated by setting the error code for the result code, and then, the UDDI response message is constituted. On the other hand, if the registration process is successful, the processing result report is generated by setting zero for the result code, and thereafter, an UDDI response message is constituted.

Furthermore, in case an analyzed ebXML request message type is a query response, the ebXML-UDDI message data transform unit 316 checks whether a response result conforms to a query object. If the response result conforms to the query object, a message in accordance with an UDDI protocol is constituted based on an instance in received information that has been mapped by the mapping module unit 308. Meanwhile, if the response result does not conform to the query object, the ebXML response message is transformed into an UDDI message having an error-processed response.

For example, in case a query object of an analyzed ebXML message is the organization instance, the ebXML message is transformed into an UDDI message having a business entity element. If a query object thereof is the service instance, the ebXML message is transformed into an UDDI message having a business service element. Further, in case a query object thereof is the service binding instance, the ebXML message is transformed into an UDDI message having a binding template element. Still further, if a query object thereof is the specification link instance, the classification scheme instance or the classification node instance, the ebXML message is transformed into an UDDI message having a grouping model element.

The UDDI result message generation unit 318 generates an UDDI response message transformed by the ebXML-UDDI message data transform unit 316 and sends it to the UDDI message interface 302.

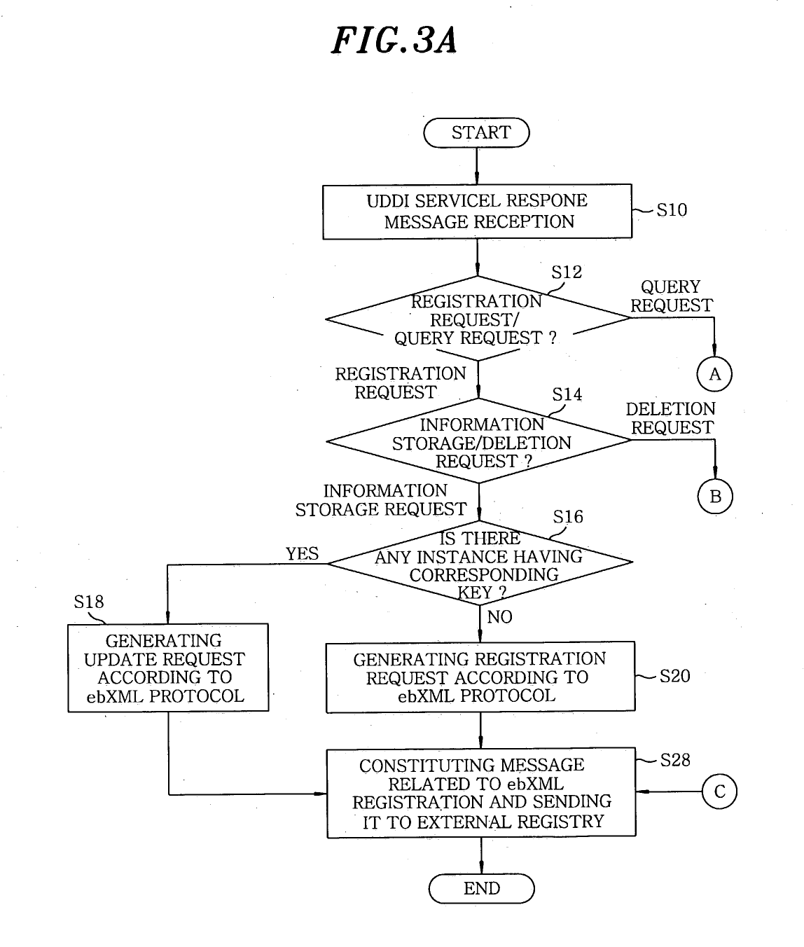

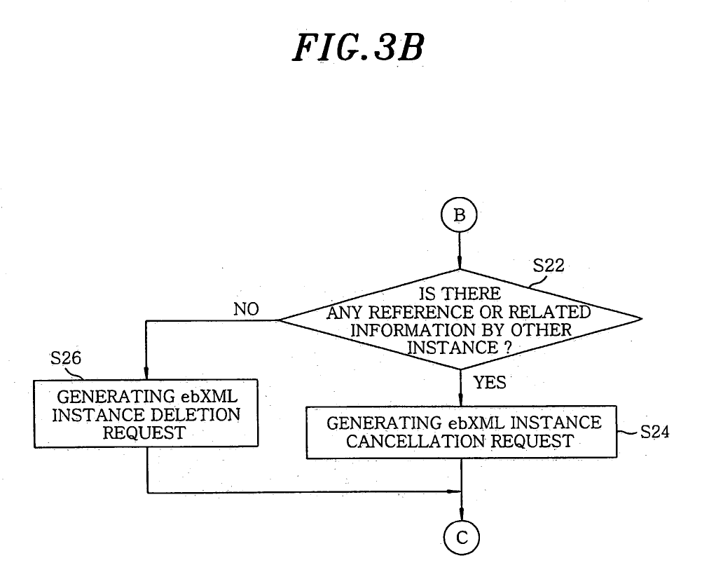

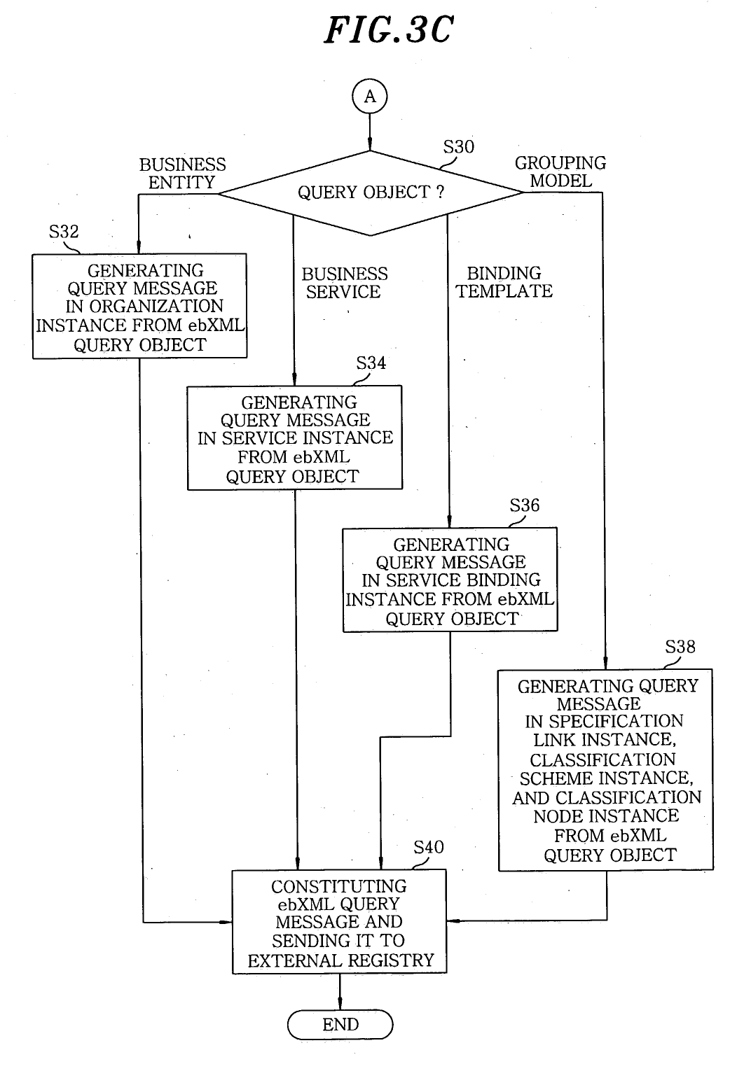

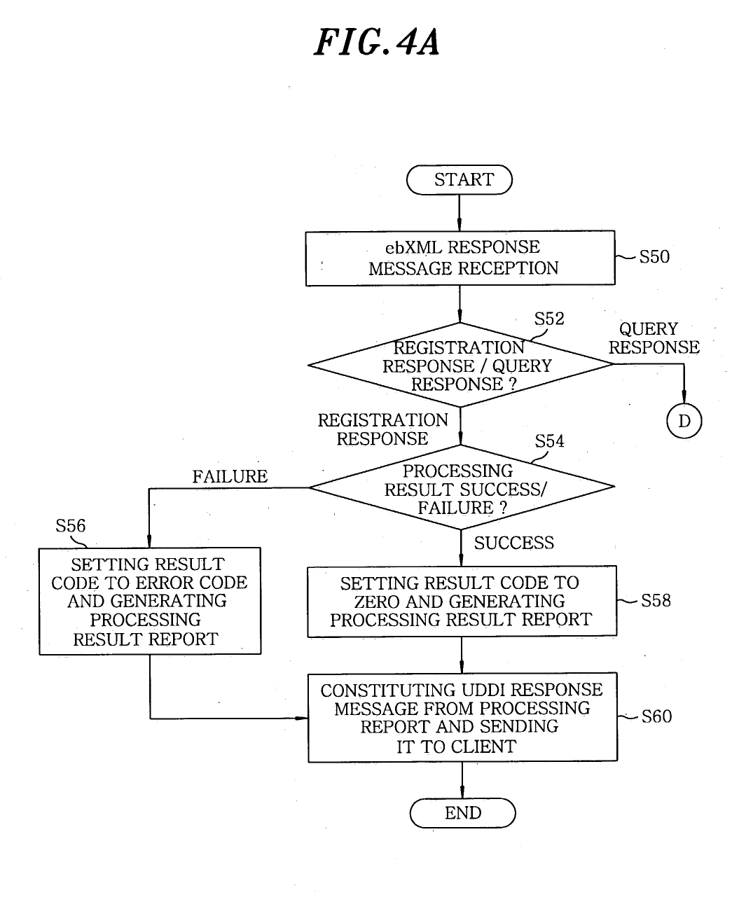

FIG. 3 depicts a flowchart of processes for transforming an UDDI message into an ebXML message and transmitting the ebXML message in the UDDI web service registry system based on the ebXML registry in accordance with a preferred embodiment of the present invention. Referring to FIG. 3, a method for managing an UDDI web service registry system based on an ebXML registry in accordance with the present invention involves transforming an UDDI message received from a client system into an ebXML message and transmitting it to an ebXML registry.

The UDDI service module 30 checks whether or not an UDDI message is received from a first or a second client system 10 or 20 through an UDDI message interface 302 (step 10).

If it is checked in the step 10 that the UDDI message is received, a request message analysis unit 304 inspects whether the UDDI message is in accordance with an UDDI protocol and then checks whether a service request of the UDDI message is a registration request or a query request (step 12). As a result of the step 12, if the service request of the UDDI message is the registration request, the request message analysis unit 304 checks again whether the service request of the UDDI message is an information storage request or a deletion request (step 14).

If it is checked in the step 14 that the service request of the UDDI message is the information storage request, the request message analysis unit 304 inquires of an ebXML registry 50 whether there exists any instance having a corresponding key (step 16). According to the result of the step 16, if there exists any instance having the corresponding key, the request message analysis unit 304 transmits an analysis result of the UDDI request message to an UDDI-ebXML message data transform unit 306.

Based on the UDDI message analysis result depending on existence or nonexistence of the information storage key, the UDDI-ebXML message data transform unit 306 transforms the UDDI message into an ebXML message having an update request (in case of the existence of the storage key) or a registration request (in case of the nonexistence of the storage key) according to an ebXML protocol (steps 18 and 20).

An ebXML request message generation unit 310 of the UDDI service module 30 generates an ebXML request message (including the update request/registration request) transformed by the UDDI-ebXML message data transform unit 306 and sends it to an ebXML registry communication module 312. The ebXML registry communication module 312 transmits the ebXML request message generated by the ebXML request message generation unit 310 to the ebXML registry 50 (step 28).

If it is checked in the step 14, if the service request of the UDDI message is the deletion request, the request message analysis unit 304 checks whether or not there exists reference or related information between a to-be-deleted instance and another instance in the ebXML registry 50 (step 22).

Then, the request message analysis unit 304 sends the analysis result to the UDDI-ebXML message data transform unit 306.

Based on the message analysis result transmitted from the request message analysis unit 304, the UDDI-ebXML message data transform unit 306 transforms the UDDI message into an ebXML message having a cancellation request (in case of existence of information) or a deletion request (in case of nonexistence of information) according to an ebXML protocol (steps 24 and 26). Specifically, if there exists the reference and the related information, corresponding information cannot be deleted, and the cancellation request is generated to avoid access from another client system. However, if the reference and the related information do not exist, the deletion request is generated to delete corresponding information.

Thereafter, the ebXML request message generation unit 310 of the UDDI service module 30 generates an ebXML request message (having the deletion request) transformed by the UDDI-ebXML message data transform unit 306 and then transmits it to an external ebXML registry communication module 312. The ebXML registry communication module 312 transmits the ebXML request message generated by the ebXML request message generation unit 310 to the ebXML registry 50 (step 28).

According to the check result of the step 12, if the service request of the UDDI message is the query request, the request message analysis unit 304 checks a query object of the UDDI message. A query object defined by the UDDI protocol is searched among a business entity, a business service, a binding template, a grouping model and the like and then transmitted to the UDDI-ebXML message data transform unit 306 (step 30).

For instance, in case a query object of the UDDI message transmitted from the request message analysis unit 304 is the business entity, the UDDI-ebXML message data transform unit 306 generates an ebXML query message by setting an organization instance for the query object of the UDDI message according to an ebXML protocol (step 32). If a query object thereof is the business service, an ebXML query message is generated by setting a service instance for the query object thereof (step 34). Further, in case a query object thereof is the binding template, an ebXML query message is generated by setting a service binding instance for the query object thereof (step 36). If a query object thereof is the grouping model, an ebXML query message is generated by setting a specification link instance, a classification scheme instance and a classification node instance for the query object thereof (step 38).

Thereafter, based on the UDDI-ebXML data transformed by the UDDI-ebXML message data transform unit 306, the ebXML request message generation unit 310 of the UDDI service module 30 generates an ebXML request message (including a query object) and then transmits it to the ebXML registry communication module 312. The ebXML registry communication module 312 transmits the ebXML request message generated by ebXML request message generation unit 310 to the ebXML registry 312 (step 40).

Although it is not shown in FIG. 3, in order to transform an UDDI message into an ebXML message, the ebXML message data transform unit 306 transmits information on compatibility and data transform between UDDI-ebXML message data to a mapping module unit 308 in the steps 18 to 20, the steps 24 to 26 and the steps 32 to 38, so that the mapping module unit 308 can map and manage the information.

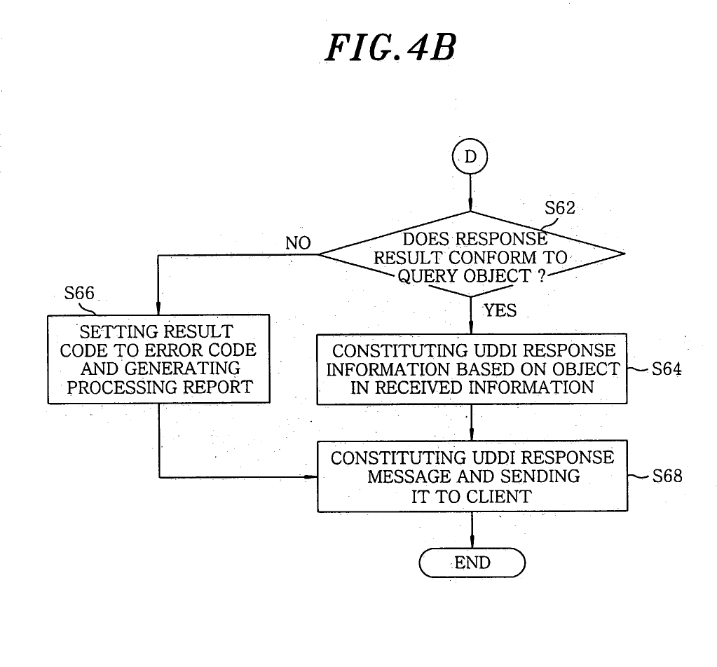

FIG. 4 provides a flowchart of processes for transforming an ebXML message into an UDDI message and transmitting the UDDI message in the UDDI web service registry system based on the ebXML registry in accordance with a preferred embodiment of the present invention.

Referring to FIG. 4, a method for managing an UDDI web service registry system based on an ebXML registry in accordance with the present invention involves transforming an ebXML response message received from an ebXML registry into an UDDI message according to an UDDI protocol and transmitting the UDDI message to a client that requested a service.

The UDDI service module 30 of the present invention checks whether or not an ebXML response message is received from the ebXML registry 50 through the ebXML registry communication module 312 (step 50).

If it is checked in the step 50 that the ebXML response message is received, the ebXML response message analysis unit 314 investigates whether the ebXML response message is in accordance with an ebXML protocol and then checks a service response of the ebXML message is a registration response or a query response (step 52).

According to the check result of the step 52, if the service response of the ebXML message is the registration response, the ebXML response message analysis unit 314 inquires of the ebXML registry 50 whether an information registration processing result in the ebXML registry 50 is successful or not (step 54).

The ebXML response message analysis unit 314 transmits the processing result (success/failure) to the ebXML-UDDI message data transform unit 316. The ebXML-UDDI message data transform unit 316 transforms the ebXML message into an UDDI message having a response of an error code or a result code according to an UDDI protocol (steps 56 and 58). Specifically, if the processing result is successful, the result code is set for zero. On the other hand, if the processing result is unsuccessful, a processing result report is generated by setting zero for the result code, and then, an UDDI message is constituted.

The UDDI result message generation unit 318 of the UDDI service module 30 generates an UDDI response message (including a registration response) transformed by the ebXML-UDDI message data transform unit 316 and then transmits it to the UDDI message interface 302. The UDDI message interface 302 transmits the UDDI response message to an UDDI module 24 of a first or a second client system 10 or 20 that requested a corresponding service (step 60).

If it is checked in the step 52 that the service response of the ebXML message is the query response, the ebXML response message analysis unit 314 analyzes whether a response result processed in the ebXML registry 50 conforms to a requested query object based on mapping-processed information by the mapping module unit 308 (step 62).

If it is checked in the step 62 that the response result conforms to the query object, the ebXML response message analysis unit 314 searches the query object, e.g., an organization instance, a service instance, a service binding instance, a specification link instance, a classification scheme instance and a classification node instance from the response result of the ebXML message to thereby transmits the analyzed result to the ebXML-UDDI message data transform unit 316.

In case the query object of the analyzed ebXML response message is the organization instance, the ebXML-UDDI message data transform unit 316 transforms the ebXML message into an UDDI message data having a business entity element according to an UDDI protocol. If the query object thereof is the service instance, the ebXML message is transformed into an UDDI message having a business service element. Further, if the query object thereof is the service binding instance, the ebXML message is transformed into an UDDI message having a binding template element. Still further, in case the query object thereof is the specification link instance, a classification scheme instance or a classification node instance, the ebXML message is transformed in to an UDDI message having a grouping model element (step 64).

Meanwhile, if it is checked in the step 62 that the response result does not conform to the query object, the ebXML response message analysis unit 314 transmits an analysis result that the response result does not conform to the query object to the ebXML-UDDI message data transform unit 316. Then, the ebXML-UDDI message data transform unit 316 transforms the ebXML message into an UDDI message having an error code as a result code according to an UDDI protocol (step 66).

After the steps 64 to 66 are performed, the UDDI result message generation unit 318 generates an UDDI response message (including a query response) according to the UDDI protocol and then sends it to the UDDI message interface 302. Thereafter, the UDDI message interface 302 transmits the UDDI response message to the UDDI module 24 of a first or a second client system 10 or 20 (step 68).

Meanwhile, if information is insufficient for transforming an ebXML message into an UDDI message, an ebXML UDDI data extension unit 52 separately installed in the ebXML registry 50 of FIG. 1 provides information to thereby reconstitute the UDDI message.

As described above, the present invention has an UDDI service module for constructing two types of systems as one in case two functions of an e-business and a web service are required so that UDDI message can be processed in an ebXML registry.

Therefore, it is possible to reduce construction costs and maintain consistency of an information management by using one system for managing same web service information.

While the invention has been shown and described with respect to the preferred embodiments, it will be understood by those skilled in the art that various changes and modifications may be made without departing from the spirit and scope of the invention as defined in the following claims.

1. An UDDI web service registry system based on an ebXML registry comprising:
a first client system for supporting a web service based on an UDDI protocol and transceiving an UDDI message;
an UDDI registry for processing a service request of the UDDI message;
a second client system for supporting a web service based on an ebXML protocol and transceiving an ebXML message;
an ebXML registry for processing service requests of the compatible ebXML message; and
an UDDI service module for transforming the UDDI message into a compatible ebXML message and transmitting the ebXML message to the ebXML registry.

2. The system of claim 1, wherein the first client system further includes a module for transmitting/receiving an ebXML message to/from the ebXML registry through an ebXML message application program.

3. The system of claim 1, wherein the second client system further includes a module for transmitting/receiving an UDDI message to/from the UDDI registry or the UDDI service module through an UDDI message application program.

4. The system of claim 1, wherein the UDDI service module includes an interface for transceiving the UDDI message, an analysis unit for analyzing a service request of the UDDI message, a data transform unit for transforming an UDDI message into a compatible ebXML message according to an ebXML protocol, a generation unit for generating the transformed ebXML request message and a communication module for transmitting the generated ebXML request message to the ebXML registry.

5. The system of claim 4, wherein the data transform unit transforms the UDDI message into an ebXML message having an update/registration request in accordance with an ebXML protocol depending on whether or not there exists an information storage key in the ebXML registry, in case the analyzed UDDI message request is an information storage request.

6. The system of claim 4, wherein the data transform unit transforms the UDDI message into an ebXML message having an ebXML instance cancellation/deletion request depending on whether or not there exists reference or related information between a to-be-deleted instance and another instance in the ebXML registry, in case the analyzed UDDI message request is a registration of a deletion.

7. The system of claim 4, wherein the data transform unit transforms the UDDI message into an ebXML query message data having an organization instance as a query object when the analyzed UDDI request message includes a query response of a business entity, the UDDI message into an ebXML query message data having a service instance as a query object when the UDDI message includes a query response of a business service, the UDDI message into an ebXML query message data having a service binding instance as a query object when the UDDI message includes a query response of a binding template, and the UDDI message into an ebXML query message data having a specification link instance, a classification scheme instance and a classification node instance when the UDDI message includes a query response of a grouping model.

8. The system of claim 1, wherein the UDDI service module transforms the ebXML response message received from the ebXML registry into a compatible UDDI message according to an UDDI protocol and then transmits the UDDI message to a client system that requested a service.

9. The system of claim 8, wherein the UDDI service module includes a communication module for transceiving the ebXML message from the ebXML registry, an analysis unit for analyzing a response type of the ebXML message, a data transform unit for transforming the ebXML message into a compatible UDDI message based on the analysis result of the analysis unit, a generation unit for generating the transformed UDDI result message and an interface for transmitting the generated UDDI result message to a client system that requested a service.

10. The system of claim 4, wherein the UDDI service module further includes a mapping module unit for performing a mapping process and managing compatibility and a data transform between UDDI-ebXML messages transformed by the UDDI message data transform unit and the ebXML message data transform unit.

11. The system of claim 9, wherein the data transform unit, in case information is not sufficient for transforming the ebXML message into a compatible UDDI message, receives information from an ebXML UDDI data extension unit separately installed in the ebXML registry and then reconstitutes an UDDI message.

12. The system of claim 9, wherein the data transform unit transforms the ebXML message into an UDDI message having a response of an error code or a result code according to a registration process result of the ebXML registry in case the analyzed ebXML message is a registration response.

13. The system of claim 9, the data transform unit transforms the ebXML message into an UDDI message having a response based on an instance in received information or an error-processed response depending on whether or not a response result conforms to a query object in case the analyzed ebXML message type is a query response.

14. The system of claim 13, wherein the data transform unit transforms the ebXML message into an UDDI message having a business entity element in case a query object of the analyzed ebXML message is an organization instance, the ebXML message into an UDDI message having a business service element in case a query object of the ebXML message is a service instance, the ebXML message into an UDDI message having a binding template element in case a query object of the ebXML message is a service binding instance, the ebXML message into an UDDI message having a grouping model element in case a query object of the ebXML message is a specification link instance, a classification link instance or a classification node instance.

15. A method for managing an UDDI web service registry system based on an ebXML registry, the method comprising the steps of:
(a) checking whether an UDDI message is received from a client system;
(b) checking whether a service request of the UDDI message is a registration request or a query request in case the UDDI message is received;
(c) checking whether there exists an information storage key in the ebXML registry in case the service request of the UDDI message is the registration request;
(d) transforming the received UDDI message into a compatible ebXML message having an update request according to an ebXML protocol in case there exists the information storage key;
(e) transforming the received UDDI message into a compatible ebXML message having a registration request according to an ebXML protocol in case the information storage key does not exist; and
(f) transmitting the transformed ebXML message to the ebXML registry.

16. The method of claim 15, wherein the step (c) is carried out in case a service request of the UDDI message is an information storage request.

17. The method of claim 15, if it is checked in the step (b) that the service request of the UDDI message is a deletion request, comprising the steps of:
checking whether there exists reference or related information between a to-be-deleted instance and anther instance in the ebXML registry;
transforming the UDDI message into a compatible ebXML message having a cancellation request of an ebXML instance according to an ebXML protocol in case there exists the reference or related information between the to-be-deleted instance and another instance;
transforming the UDDI message into a compatible ebXML message having a deletion request of an ebXML instance according to an ebXML protocol in case the reference or related information do not exist between the to-be-deleted instance and another instance; and
transmitting the transformed ebXML message to an ebXML registry.

18. The method of claim 15, if it is checked in the step (b) that the service request of the UDDI message is the query request, comprising the steps of:
transforming the UDDI message into a compatible ebXML query message having an organization instance according to an ebXML protocol in case a query response of the received UDDI message is a business entity;
transforming the UDDI message into an ebXML query message having a service instance in case a query response of the UDDI message is a business service;
transforming the UDDI message into an ebXML query message having a service binding instance in case a query response of the UDDI message is a binding template;
transforming the UDDI message into an ebXML query message having a specification link instance, a classification scheme link and a classification node instance in case a query response of the UDDI message is a grouping model; and
transmitting the transformed ebXML message to an ebXML registry.

19. A method for managing an UDDI web service registry system based on an ebXML registry, the method comprising the steps of:
(a′) checking whether an ebXML message is received from the ebXML registry;
(b′) checking whether a response type of the received ebXML message is a registration response or a query response;
(c′) transforming the ebXML message into a compatible UDDI message having a response of an error code or a result code according to an UDDI protocol in case the ebXML message type is the registration response;
(d′) transforming the ebXML message into a compatible UDDI message having a response based on an instance in received information or an error-processed response according to an UDDI protocol depending on whether a response result conforms to a query object in case the ebXML message is the query response; and
(e′) transmitting the transformed UDDI message to a request client system.

20. The method of claim 19, wherein the step (d′) further includes the steps of:
transforming the ebXML message into a compatible UDDI message having a response based on an instance in received information according to an UDDI protocol depending on whether a response result conforms to a query object in case the ebXML message type is a query response;
transforming the ebXML message into a compatible UDDI message having a business entity element according to an UDDI protocol in case the received ebXML message has an organization instance;
transforming the ebXML message into a compatible UDDI message having a business service element according to an UDDI protocol in case the received ebXML message has a service instance;
transforming the ebXML message into a compatible UDDI message having a binding template element according to an UDDI protocol in case the received ebXML message has a service binding instance; and
transforming the ebXML message into a compatible UDDI message having a grouping model element according to an UDDI protocol in case the received ebXML message has a specification link instance, a classification scheme instance or a classification node instance.

21. The method of claim 19, wherein the steps (c′) and (d′) further includes the step of reconstituting an UDDI message by receiving information from an ebXML UDDI data extension unit separately installed in the ebXML registry if information is insufficient to perform a transform.
